(19) United States
(12) Patent Application Publication
(10) Pub. No.: US 2026/0113634 A1
(43) Pub. Date: Apr. 23, 2026

(54) METHOD OF ESTABLISHING WIRELESS CONNECTION AND ACCESS POINT AND CLIENT DEVICE PERFORMING THE METHOD

(71) Applicant: TP-Link Systems Inc., IRVINE, CA (US)

(72) Inventor: Jie GUAN, Chengdu (CN)

(73) Assignee: TP-Link Systems Inc., IRVINE, CA (US)

(21) Appl. No.: 18/921,604

(22) Filed: Oct. 21, 2024

(51) Int. Cl. H04W 12/084; H04W 12/069; H04W 76/10; H04W 84/12

(52) U.S. Cl. CPC H04W 12/084; H04W 12/069; H04W 76/10; H04W 84/12

(57) ABSTRACT

A method of establishing a wireless connection by an access point (AP) is provided. The method includes: receiving, an access request indicating that a client device is requesting access to a target network using the Wi-Fi protected access 3 (WPA3) protocol created by the AP; acquiring, a target private pre-shared key (PSK) to be used by the client device to connect to the target network according to a security protocol different from the WPA3 protocol; and controlling, the client device to connect to the target network according to the WPA3 protocol using the target private PSK in response to the target private PSK being correct.

### TECHNICAL FIELD

The present disclosure relates to wireless communication, and more particularly, to a method of establishing a wireless connection between an access point (AP) and a client device and the AP and the client device performing the method.

### BACKGROUND

Compared to the Wi-Fi protected access 2 (WPA2) protocol, the Wi-Fi protected access 3 (WPA3) protocol introduces the simultaneous authentication of equals (SAE) authentication process, which greatly enhances authentication and encryption, improves protection against eavesdropping and spoofing, and provides mitigation measures against wireless attacks such as the key reinstallation attack (KRACK) and the de-authentication flood attack (DEAUTH). The current private PSK technology is applicable to WPA2 protocol wireless networks but is not applicable to the WPA3 protocol. There is a need for an improved mechanism for using a private PSK to access a wireless network using the WPA3 protocol.

### SUMMARY

In view of the above problem, the present application provides techniques for establishing a wireless connection between the client device and the AP, ensuring that the client device can use a private PSK to access the wireless network using the WPA3 protocol provided by the AP.

According to an aspect of the present disclosure, a method of establishing a wireless connection by an access point is provided. The method comprises: receiving an access request indicating that a client device is requesting access to a target network using Wi-Fi protected access 3 (WPA3) protocol created by the AP; acquiring a target private pre-shared key (PSK) to be used by the client device to connect to the target network according to a security protocol different from the WPA3 protocol; and controlling the client device to connect to the target network according to the WPA3 protocol using the target private PSK in response to the target private PSK being correct.

According to an aspect of the present disclosure, a method of establishing a wireless connection by an access point is provided. The method comprises: transmitting, to an access point (AP), an access request indicating that the client device is requesting access to a target network using Wi-Fi protected access 3 (WPA3) protocol created by the AP; providing, to the AP, a target private pre-shared key (PSK) to be used by the client device to connect to the target network according to a security protocol different from the WPA3 protocol; and performing a simultaneous authentication of equals (SAE) authentication process specified by the WPA3 protocol using the target private PSK in response to receiving a connection indication instructing the client device to establish a connection with the AP according to the WPA3 protocol.

According to an aspect of the present disclosure, an AP is provided. The AP comprises a memory storing instructions thereon and a processor coupled with the memory. The processor is configured to execute the instructions to cause the AP to: receive an access request indicating that a client device is requesting access to a target network using Wi-Fi protected access 3 (WPA3) protocol created by the AP; acquire a target private pre-shared key (PSK) to be used by the client device to connect to the target network according to a security protocol different from the WPA3 protocol; and control the client device to connect to the target network according to the WPA3 protocol using the target private PSK in response to the target private PSK being correct.

According to an aspect of the present disclosure, a client device is provided. The client device comprises a memory storing instructions thereon and a processor coupled with the memory. The processor is configured to execute the instructions to cause the client device to: transmit to an access point (AP) an access request indicating that the client device is requesting access to a target network using Wi-Fi protected access 3 (WPA3) protocol created by the AP; provide to the AP a target private pre-shared key (PSK) to be used by the client device to connect to the target network according to a security protocol different from the WPA3 protocol; and perform a simultaneous authentication of equals (SAE) authentication process specified by the WPA3 protocol using the target private PSK in response to receiving a connection indication instructing the client device to establish a connection with the AP according to the WPA3 protocol.

A computer program product, including computer-readable medium storing instructions thereon, when executed by a processor of an AP causes the processor to perform operations of: receiving an access request indicating that a client device is requesting access to a target network using Wi-Fi protected access 3 (WPA3) protocol created by the AP; acquiring a target private pre-shared key (PSK) to be used by the client device to connect to the target network according to a security protocol different from the WPA3 protocol; and controlling the client device to connect to the target network according to the WPA3 protocol using the target private PSK in response to the target private PSK being correct.

A computer program product, including computer-readable medium storing instructions thereon, when executed by a processor of a client device causes the processor to perform operations of: transmitting to an AP an access request indicating that the client device is requesting access to a target network using Wi-Fi protected access 3 (WPA3) protocol created by the AP; providing to the AP a target private pre-shared key (PSK) to be used by the client device to connect to the target network according to a security protocol different from the WPA3 protocol; and performing a simultaneous authentication of equals (SAE) authentication process specified by the WPA3 protocol using the target private PSK in response to receiving a connection indication instructing the client device to establish a connection with the AP according to the WPA3 protocol.

With the techniques of the present application, the AP can obtain the target private PSK to be used by the client device to access the target network using the WPA3 protocol before performing the SAE authentication process specified by the WPA3 protocol, such that the AP and the client device can use the same private PSK to perform the SAE authentication process. This ensures that the SAE authentication process is successful even if the client device is configured with multiple private PSKs and uses any one of the configured multiple private PSKs, thereby facilitating the client device to successfully connect to the target network.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure but do not constitute a limitation on the present disclosure. In the drawings, unless otherwise explicitly indicated, the same reference numerals refer to the same components, steps, or elements.

FIG. 1 shows the first exemplary system for establishing a wireless connection between the client device and the AP according to the first embodiment of the present disclosure;

FIG. 2 shows an exemplary schematic diagram illustrating an example interaction among the entities of the first exemplary system according to the first embodiment of the present disclosure;

FIGS. 3a and 3b show exemplary schematic diagrams illustrating example interactions between the AP and a data management server for verifying the target private PSK according to an embodiment of the present disclosure;

FIG. 4 shows the second exemplary system for establishing a wireless connection between the client device and the AP according to the second embodiment of the present disclosure;

FIG. 5 shows an exemplary schematic diagram illustrating an example interaction among the entities of the second exemplary system according to the second embodiment of the present disclosure;

FIG. 6 shows the third exemplary system for establishing a wireless connection between the client device and the AP according to the third embodiment of the present disclosure;

FIG. 7 shows an exemplary schematic diagram illustrating an example interaction among the entities of the third exemplary system according to the third embodiment of the present disclosure;

FIG. 8 shows an exemplary schematic diagram illustrating an example flow chart of the method of establishing a wireless connection by the AP according to an embodiment of the present disclosure;

FIG. 9 shows an exemplary schematic diagram illustrating an example flow chart of the method of establishing a wireless connection by the client device according to an embodiment of the present disclosure;

FIG. 10 is an exemplary block diagram illustrating an example AP according to an embodiment of the present disclosure; and

FIG. 11 is an exemplary block diagram illustrating an example client device according to an embodiment of the present disclosure.

### DETAILED DESCRIPTION

The technical solution of the present disclosure will be clearly and completely described below in conjunction with accompanying drawings. The described embodiments are part of embodiments of the present disclosure, but not all of them. Based on the embodiments in the present disclosure, all other embodiments acquired by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined as long as no conflicts occur therebetween.

Some of the drawings may not depict all the components of a given method, device and system. Like reference numerals may be used to denote like features throughout the specification and drawings.

A traditional wireless network uses a scheme in which all client devices share a public PSK to access the wireless network. If a client device's access qualification to the wireless network needs to be revoked due to an accident, such as a leak or cracking of the public PSK, the network administrator must change the public PSK, which results in the disruption of network qualification for all client devices, and thereby negatively impacting the user experience. To solve this problem, each client device can be configured with its own one or more private PSK to access the wireless network. Invalidating the private PSK(s) of one client device does not invalidate the private PSK(s) of other client devices.

As mentioned previously, the WPA3 protocol introduces the SAE authentication process compared to the WPA2 protocol, making it more effective in preventing wireless attacks such as KRACK and DEAUTH. To ensure the success of the SAE authentication process, the peer entities (such as the client device and the AP) must perform the SAE authentication process using the same private PSK because the SAE authentication process is an authentication process in which the peer entities generate authentication information independently, rather than one of the peer entities requesting the other to authenticate. The SAE authentication process may fail if the AP uses a private PSK that is different from the one used by the client device to perform SAE authentication. This may lead the client device to be unable to access the target network even though it uses a correct private PSK. For example, the AP and the client device may each independently calculate a confirm field based on a private PSK using, for example, a hash algorithm. The confirm field calculated by the AP is closely related to the private PSK used by the AP and the confirm field calculated by the client device is closely related to the private PSK used by the client device. The AP may include its calculated confirm field in an SAE authentication frame and send this frame to the client device. The client device may also include its calculated confirm field in an SAE authentication frame and send this frame to the AP. Upon receiving the client device's SAE Authentication frame, the AP may compare the received confirm field with its own calculated confirm field. If the received confirm field and its own calculated confirm field are the same, it indicates that the private PSKs used by both the client device and the AP are identical, and the AP may determine that the SAE authentication is successful. If the received confirm field and its own calculated confirm field are different, the AP may determine that the SAE authentication fails. Similarly, the client device may also compare the confirm field included in the SAE authentication frame received from the AP with its own calculated confirm field and determine that the SAE authentication is successful based on the consistency of the received confirm field and its own calculated confirm field.

The first to three embodiments of the present disclosure enable the AP to acquire the target private PSK to be used by the client device to establish a wireless connection with the target network according to a security protocol different from the WPA3 protocol before controlling the client device to connect to the target network according to the WPA3 protocol. In this way, the client device and the AP can use the same private PSK to perform the SAE process, ensuring the success of the SAE authentication process so that the client device can access the target network using the WPA3 protocol.

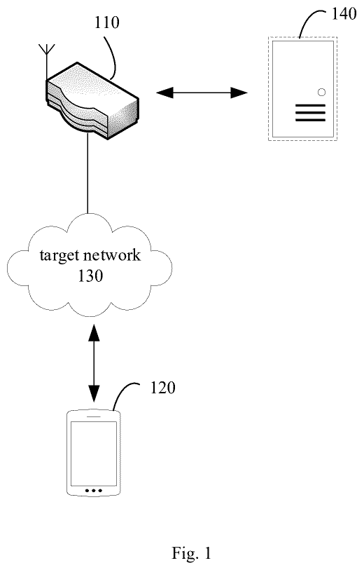

The first embodiment according to the present disclosure will be described below with reference to FIGS. 1 to 3.

FIG. 1 shows the first exemplary system for establishing wireless connection between the client device and the AP according to the first embodiment of the present disclosure.

Referring to FIG. 1, the first exemplary system 10 may comprise an AP 110, a client device 120, and a data management server 140. The AP 110 may create a Wi-Fi network 130 (hereinafter referred to as the target network 130) that uses the WPA3 protocol. The client device 120 may be configured with a plurality of private PSKs that can be used to connect to the AP 110. The data management server 140 may control and coordinate, including but not limited to, the collection, storage, protection, encryption, decryption, archiving, and destruction of the data generated during the interactions among the respective entities of the first exemplary system 10. When the user of the client device 120 desires to access the target network 130, the user may use one of a plurality of private PSKs to request access to the target network 130. As mentioned previously, the SAE authentication process will be successful only if the client device 120 and the AP 110 use the same private PSK to perform the SAE authentication process and will fail if the client device 120 and the AP 110 use different private PSKs to perform the SAE authentication process.

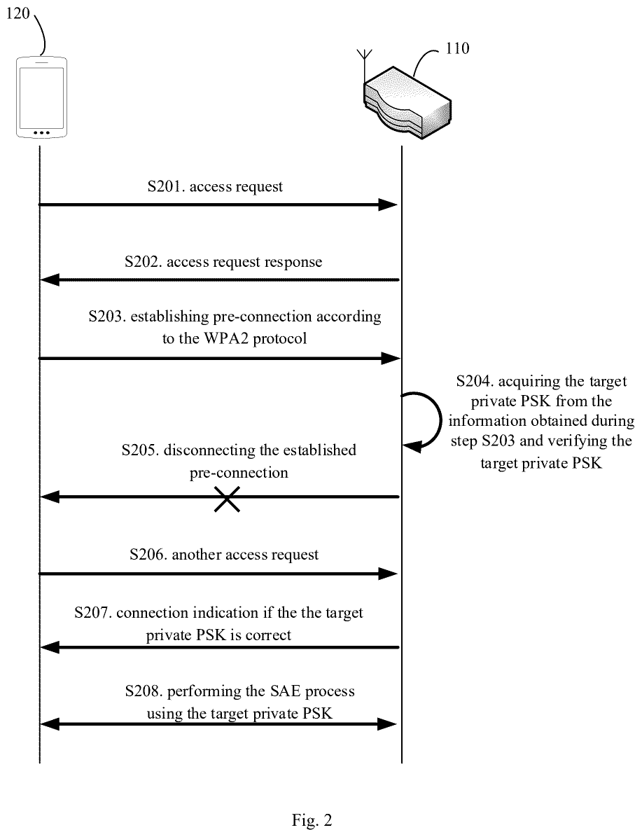

In the first embodiment, the AP 110 may acquire the target private PSK to be used by the client device 120 to connect to the target network 130 according to the WPA2 protocol before performing the SAE authentication process specified by the WPA3 protocol. That is, in the first embodiment, the above-mentioned security protocol different from the WPA3 protocol may be the WPA2 protocol. The details will be described with reference to FIG. 2.

FIG. 2 shows an exemplary schematic diagram illustrating an example interaction among the entities of the first exemplary system according to the first embodiment of the present disclosure.

Referring to FIG. 2, at step S201, the client device 120 may transmit to the AP 110 an access request indicating that the client device 120 is requesting access to the target network 130 using the WPA3 protocol created by the AP 110. In one example, the access request may be a probe request frame or may be included in the probe request frame and may comprise an information element associated with the client device 120, such as the MAC address of the client device 120.

At step S202, in response to receiving the access request, the AP 110 may transmit to the client device 120 an access request response instructing the client device 120 to establish a connection with the AP 110 according to the WPA2 protocol. In one example, the access request response may be a probe response frame or may be included in the probe response frame and may comprise an information element indicating that the security protocol supported by the AP 110 is the WPA2 protocol. Meanwhile, the AP 110 may downgrade the security protocol of the target network 130 from the WPA3 protocol to the WPA2 protocol.

At step 203, in response to receiving the access request response, the client device 120 may establish a pre-connection with the AP 110 according to the WPA2 protocol such that the AP 110 can acquire the target private PSK during the establishment of the connection. In one example, the client device 120 may establish the pre-connection with the AP 110 through the four-way handshake process specified by the WPA2 protocol. As known, according to the WPA2 protocol, the client device 120 may transmit an SNonce (i.e., a random number generated by the client device 120) and a message integrity check (MIC) to the AP 110 in the second step of the four-way handshake. The MIC is associated with the target private PSK. Specifically, the MIC is generated based on the first 16 bytes of a pairwise transient key (PTK). The PTK is generated based on a pairwise master key (PMK), an ANonce (i.e., a random number generated by the AP 110), the MAC address of the client device 120 and the MAC address of the AP 110. The PMK is calculated from the target private PSK and the SSID (Service Set Identifier) of the target network 130.

At step 204, the AP 110 may acquire the target private PSK from the information obtained during step S203 and verify the target private PSK. In one example, the AP 110 may abstract the MIC from the information obtained during the four-way handshake process and then derive the target private PSK from the MIC in a manner inverse to the manner used by the client device 120 to generate the MIC, or then retrieve the target private PSK from a mapping between the MIC and the target private PSK pre-stored by the network administrator. The AP 110 may then verify the target private PSK.

In this way, by downgrading the security protocol of the target network 130 from the WPA3 protocol to the WPA2 protocol, the client device 120 is allowed to establish a pre-connection with the AP 110 such that the AP 110 can acquire the target private PSK according to the WPA 2 protocol.

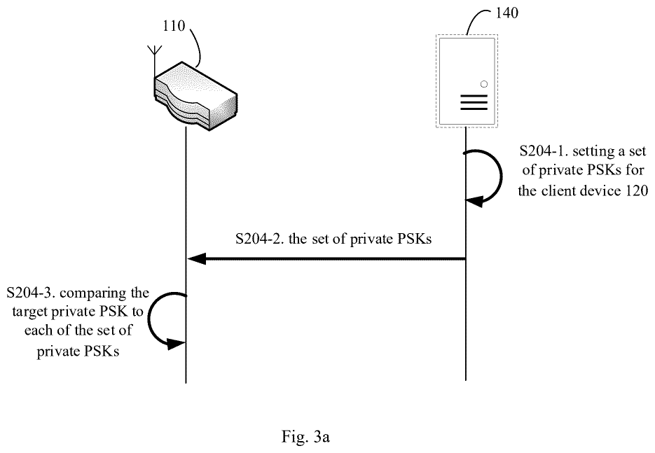

FIGS. 3a and 3b show exemplary schematic diagrams illustrating an example interaction between the AP and the data management server 140 for verifying the target private PSK according to an embodiment of the present disclosure.

Referring to FIG. 3a, in one example, step S204 may comprise substeps S204-1 and S204-3. At substep S204-1, a set of private PSKs configured for the client device 120 may be set and stored at the data management server 140 by a network administrator. In one example, the set of private PSKs may be wet not to be bound to any MAC address. In another example, the set of private PSKs may be set to bind to a MAC address (such as the MAC address of the client device 120). At substep S204-2, the data management server 140 may distribute the set of private PSKs associated with the client device 120 to the AP 110 after the set of private PSKs is set in the data management server 140. In the case where the set of private PSKs is set to bind to a MAC address, the data management server 140 may also inform the AP 110 of the binding relationship between the set of private PSKs and the MAC address. In substep S204-3, the AP 110 may determine whether the target private PSK is correct. Specifically, in the case where the set of private PSKs is not bound to a MAC address, the AP 110 may compare the target private PSK to each of the set of private PSKs associated with the client device 120 and determine the target private PSK to be correct based on that the target private PSK matches one private PSK of a set of private PSKs associated with the client device 120. In the case where the set of private PSKs is bound to a MAC address, the AP 110 may compare the target private PSK to each of the set of private PSKs and determine the target private PSK to be correct based on that the target private PSK matches one private PSK of a set of private PSKs and that the MAC address of the client device 120 matches the MAC address to which the matched private PSK is bound.

Referring to FIG. 3b, in another example, the step S204 may comprise substeps S204-1′ to S204-4′. It should be noted that the operations at substep S204-1′ are the same as those at substep S204-1, and details for operations at substep S204-1′ are omitted herein for conciseness. At substep S204-2′, the client device 120 may transmit the acquired target private PSK to the data management server 140. At substep S204-3′, the data management server 140 may determine whether the target private PSK is correct. Specifically, in the case where the set of private PSKs is not bound to a MAC address, the data management server 140 may compare the target private PSK to each of the set of private PSKs associated with the client device 120 and determine the target private PSK to be correct based on the target private PSK matches one private PSK of a set of private PSKs associated with the client device 120. In the case where the set of private PSKs is bound to a MAC address, the data management server 140 may compare the target private PSK to each of the set of private PSKs associated with the client device 120 and determine the target private PSK to be correct based on that the target private PSK matches one private PSK of a set of private PSKs and that the MAC address of the client device 120 matches the MAC address to which the matched private PSK is bound. At the substep S204-4′, the data management server 140 may return a comparing result message indicating whether the target private PSK is correct to the AP 110.

In this way, the AP 110 can easily verify the acquired target private PSK by comparing it with the set of private PSKs preconfigured at the data management server 140. If one or more of the set of private PSKs is leaked due to an attack and/or vulnerability such as side channel attack and/or dragonfly handshake vulnerability, etc., it is only necessary to delete the one or more leaked private PSKs at the data management server 140 without resetting the entire set of private PSKs, thereby avoiding a negative impact on the client device 120.

Referring back to FIG. 2, at step 205, the AP 110 may disconnect the client device 120 from the established pre-connection. At step 206, the client device 120 may transmit another access request indicating that the client device 120 is requesting access to the target network 130. The other access request is similar to the access request in step S201. For example, the AP 110 may transmit the de-authentication frame to the client device 120 to disconnect the client device 120. The other access request may be in the form of a probe request frame or may be included in a probe request frame and include an information element associated with the client device 120, such as the MAC address of the client device 120.

At step 207, in response to receiving the other access request, the AP 110 may transmit, to the client device 120, a connection indication instructing the client device 120 to establish connection with the AP 110 according to the WPA3 protocol if the target private PSK is verified to be correct in step S204, or the AP 110 may transmit, to the client device 120, a rejection indication indicating that the client device 120 is rejected to connect to the AP 110 if the target private PSK is not verified to be correct in step S204. The connection indication may be in the form of a probe response frame or may be included in the probe response frame. The rejection indication may be in the form of a de-authentication frame or may be included in the de-authentication frame. Meanwhile, the AP 110 may upgrade the security protocol of the target network 130 from the WPA2 protocol to the WPA3 protocol.

At step 208, the client device 120 and the AP 110 may perform the SAE authentication process specified by the WPA3 protocol using the target private PSK. In this step, both the client device 120 and the AP 110 calculate their own confirm fields based on the same target private PSK, such that the calculated confirm fields of the client device 120 and the AP 110 are the same, thereby ensuring that the SAE authentication will be successful.

As such, the AP 110 can acquire the target private PSK to be used by the client device 120 to connect to the target network 130 according to the WPA3 protocol by downgrading the security protocol to the WPA2 protocol before performing the SAE authentication process specified by the WPA3 protocol, thereby ensuring that the client device 120 and the AP 110 use the same target private PSK to perform the SAE authentication process. This can ensure the success of the SAE authentication process as long as the target private PSK is correct and facilitates the client device 120 to connect to the target network according to the WPA3 protocol.

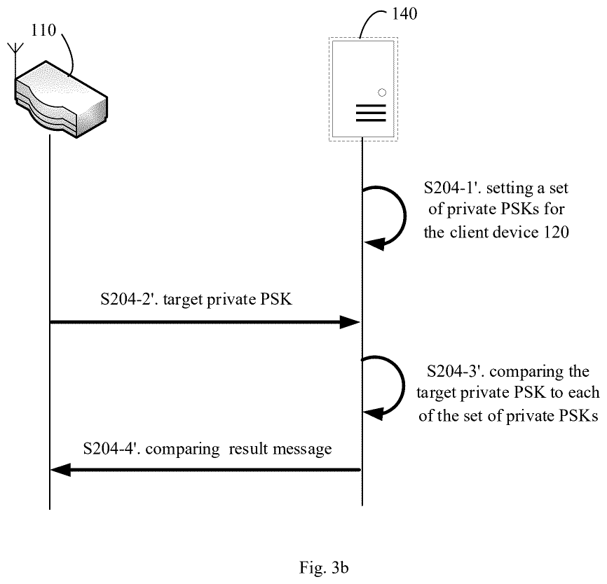

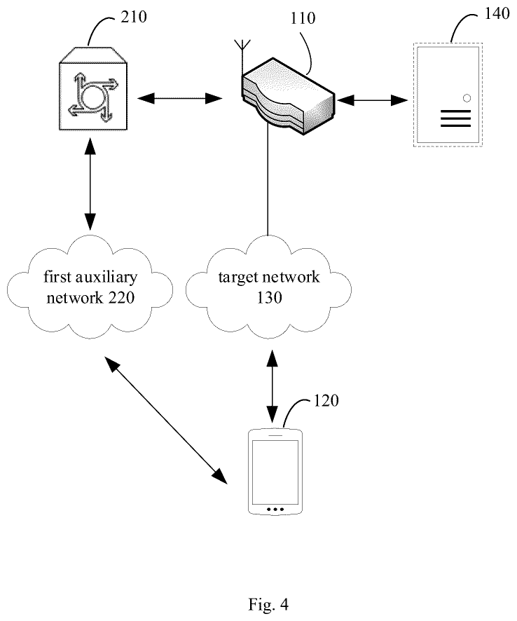

The second embodiment according to the present disclosure will be described below with reference to FIGS. 4 to 5.

FIG. 4 shows the second exemplary system for establishing a wireless connection between the client device and the AP according to the second embodiment of the present disclosure.

Referring to FIG. 4, the second exemplary system 20 may comprise the AP 110, the client device 120, the data management server 140, and an intermediate server 210. The intermediate server 210 may communicate with the AP 110 and the client device 120 via a first auxiliary network 220 that uses the hypertext transfer protocol secure (HTTPS) protocol. For example, the first auxiliary network 220 may be a cellular network, mobile network, or any other network that is different from the target network 130. When the user of the client device 120 desires to access the target network 130, the user may establish pre-connection with intermediate server 210 via the first auxiliary network 220 such that the intermediate server 210 can relay the target private PSK of the client device 120 to the AP 110 according to the HTTPS protocol. That is, in the second embodiment, the above-mentioned security protocol different from the WPA3 protocol may be the HTTPS protocol. The details will be described with reference to FIG. 5.

Referring to FIG. 5, at step S501, upon detecting that the client device 120 is connected to the first auxiliary network 220, the intermediate server 210 may transmit a list of networks including the target network 130 to the client device 120 via the first auxiliary network 220. For ease of explanation, given the first auxiliary network 220 is the cellular network and the intermediate server 210 is associated with an application installed on the client device 120. After the client device 120 connects to the cellular network, as long as the client device 120 activates the application (e.g., the client device 120 may be a mobile phone and the user may touch the application on the screen of the mobile phone to activate the application), the intermediate server 210 may detect that the client device 120 is connected to the first auxiliary network 220. The intermediate server 210 may then transmit the list of networks including the target network 130 to the client device 120. The client device 120 may present the list of networks to the user via the application. The user may input a gesture command for selecting the target network 130 from the list of the network via the application. At step S502, the client device 120 may select the target network 130 from the list of the networks in response to the gesture command.

At step S503, the intermediate server 210 may transmit to the client device 120 a private PSK request for requesting the target private PSK of the client device 120 in response to the selection of the target network 130 at step S502.

At step S504, the client device 120 may transmit the target private PSK via the first auxiliary network 220 in response to receiving the private PSK request. For example, the private PSK request may be presented via the application to the user and the user may input the target private PSK via the application. The client device 120 may transmit the target private PSK in response to the input of the user.

At step S505, the intermediate server 210 may include the target private PSK in the access request and transmit the access request to the AP 110 to indicate that the client device 120 is requesting access to a target network 130 using the WPA3 protocol.

At step S506, the AP 110 may abstract the target private PSK from the access request received at step S505 and verify the target private PSK. It should be noted that the operations for verifying the target private PSK in step S506 are the same as the operations for verifying the target private PSK in step 204, and details for verifying the target private PSK in step S506 are omitted herein for conciseness.

In this way, by enabling the client device 120 to establish a pre-connection with the AP 110 via the intermediate server 210 and the first auxiliary network 220 that uses HTTPS protocol, the AP 110 can acquire the target private PSK before performing the SAE authentication process.

It should be noted that the first auxiliary network 220 may also use one or more security protocols different from the WPA3 protocol in addition to the HTTPS protocol, such as TLS/SSL (Transport Layer Security/Secure Sockets Layer), IPSec (Internet Protocol Security), SSH (Secure Shell), Kerberos, RADIUS (Remote Authentication Dial-In User Service), OAuth (Open Authorization), SAML (Security Assertion Markup Language) protocol, DTLS (Datagram Transport Layer Security), PEAP (Protected Extensible Authentication Protocol), HTTP (HyperText Transfer Protocol), WebSocket Protocol, XMPP (Extensible Messaging and Presence Protocol) etc.

At step S507, the AP 110 may return to the intermediate server 210 a verification result message indicating whether the target private PSK is correct.

At step S508, the intermediate server 210 may transmit to the client device 120 a connection indication instructing the client device 120 to establish connection with the AP 110 according to the WPA3 protocol if the received verification result message indicates that the target private PSK is correct, or the intermediate server 210 may transmit to the client device 120 a rejection indication indicating that the client device 120 is rejected to connect to the AP 110 if the received verification result message indicates that the target private PSK is incorrect.

At step S509, the client device 120 and the AP 110 may perform the SAE authentication process specified by the WPA3 protocol using the target private PSK. In this step, both the client device 120 and the AP 110 calculate their own the confirm fields based on the same target private PSK, such that the calculated confirm fields of the client device 120 and the AP 110 are the same, thereby ensuring that the SAE authentication will be successful.

As such, the AP 110 can acquire the target private PSK to be used by the client device 120 to connect to the target network 130 via the first auxiliary network 220 which is different from the target network 130, thereby ensuring that the client device 120 and the AP 110 use the same target private PSK to perform the SAE authentication process. This can ensure the success of the SAE authentication process as long as the target private PSK is correct and facilitates the client device 120 to connect to the target network according to the WPA3 protocol.

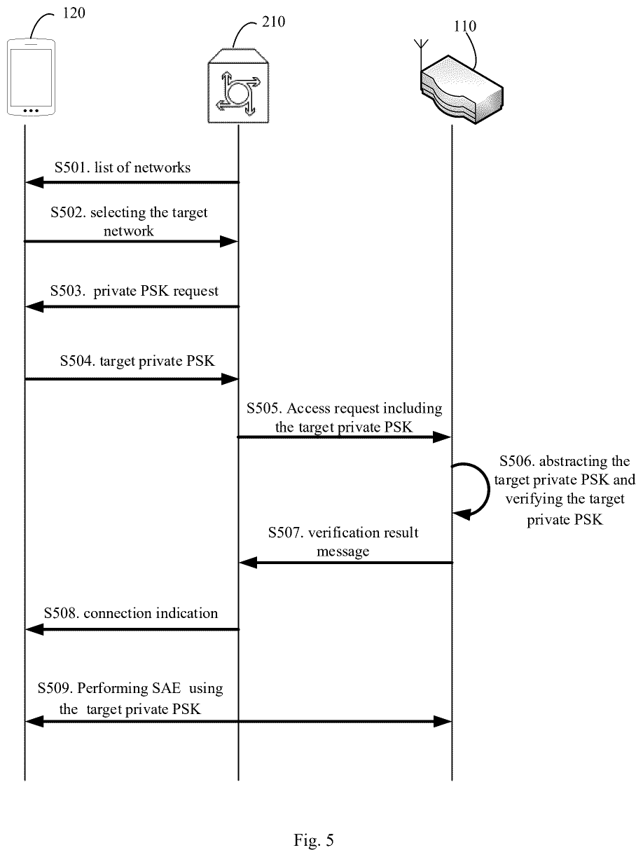

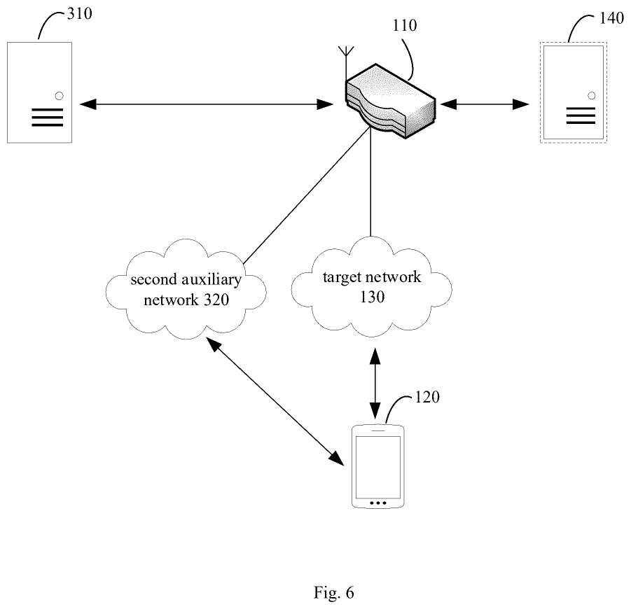

The third embodiment according to the present disclosure will be described below with reference to FIGS. 6 to 7.

FIG. 6 shows the third exemplary system for establishing a wireless connection between the client device and the AP according to the third embodiment of the present disclosure.

Referring to FIG. 6, the third exemplary system 30 may also comprise the AP 110, the client device 120, and a portal server 310 that uses the portal authentication protocol. The AP 110 may create the target network 130 that uses the WPA3 protocol and an unencrypted Wi-Fi network as the second auxiliary network 320. When the user of the client device 120 desires to access the target network 130, the user may establish pre-connection with the AP 110 via the second auxiliary network 320, such that the AP 110 may redirect the client device 120 to the portal server 310 and verify the identity credential of the client device 120 combined with the portal server 310. After verifying that the identity credential of the client device 120 is correct, the client device 120 may allow the client device 120 to set a target private PSK to be used by the client device 120 to connect to the target network 130 and then use the set target private PSK to perform the SAE authentication process specified by the WPA3 protocol. In one example, the set target private PSK may be stored in a memory of the AP 110. In another example, the third exemplary system 30 may further include the data management server 140 and the set target private PSK may be stored in the data management server 140. The network administrator may manage the set target private PSK, such as deleting the set target private PSK from the data management server 140. That is, in the third embodiment, the above-mentioned security protocol different from the WPA3 protocol may be the portal authentication protocol. The details will be described with reference to FIG. 7.

FIG. 7 shows an exemplary schematic diagram illustrating an example interaction among the entities of the third exemplary system according to the third embodiment of the present disclosure.

Referring FIG. 7, at step S701, the AP 110 may create the unencrypted Wi-Fi network as the second auxiliary network 320 such that the client device 120 may establish pre-connection with the AP 110 via the second auxiliary network 320.

At step S702, the client device 120 may transmit to the AP 110 the access request indicating that a client device is requesting access to a target network 130 to the AP 110 via the second auxiliary network 320. In this embodiment, the access request may be in the form of an HTTP request. At step S703, the AP 110 may redirect the client device 120 to the portal server 310. For example, the AP 110 returns a redirection response that comprises the URL of the portal server 310 to the client device 120 after receiving the access request. The client device 120 may transmit a new HTTP request to the URL of the portal server 310 after receiving the redirection response.

At step S704, the portal server 170 may transmit to the client device 120 a portal authentication request for requesting an identity credential of the client device 120. At step S705, the client device 120 may transmit the identity credential of the client device 120 to the portal server 170. At step S706, the portal server 170 may forward the identity credential of the client device 120 to the AP 110. At step S707, the AP 110 may determine whether the identity credential of the client device 120 is correct and then transmit to the portal server an authentication result message indicating whether the authentication for the identity credential of the client device 120 is successful. The way that AP 110 can use to verify identity credentials include, but are not limited to: authentication-free, account password authentication, RADIUS (Remote Authentication Dial in User Service) server authentication, mobile phone verification code authentication, email authentication, and combinations thereof.

At step S708, the portal server 310 may transmit a private PSK setting indication to the client device 120 to instruct the client device 120 to set the target private PSK if the authentication result message received in step S707 indicates that the authentication for the identity credential of the client device 120 is successful, or the portal server 310 may transmit a rejection indication to the client device 120 indicating that the client device 120 is rejected to connect to the AP 110 if the authentication for the identity credential of the client device 120 fails. The private PSK setting indication may cause the user of the client device 120 to set his or her own private PSK, or to select a private PSK with a certain length and/or the format (e.g., whether to include a letter and/or a special character, etc.) that is automatically generated by the AP 110 or the data management server 140. At step S709, the client device 120 may transmit the target private PSK to the portal server 170. At step S710, the portal server 310 may forward the set target private PSK to the AP 110.

In this way, by enabling the client device 120 to establish a pre-connection with the AP 110 via the second unencrypted auxiliary network 220 and by verifying the client device 120 utilizing the portal server 310 according to the portal authentication protocol, the AP 110 can acquire the target private PSK before performing the SAE authentication process.

At step S711, the AP 110 may return a target private PSK acknowledgment message to the portal server 310. At step S712, the portal server 310 may forward the target private PSK acknowledgment message to the client device 120. In these steps, the AP 110 does not verify the target private PSK set by the client device 120 but defaults it is correct as long as the identity credential of the client device 120 has been verified successfully. That is, the target private PSK being correct is based on a verification of the identity credential being successful.

In this way, by allowing the client device 120 to set the target private PSK rather than pre-configuring the set of the private PSKs for the client device 120, the flexibility of setting the private PSK can be increased and the user experience can be improved.

At step S713, the AP 110 may disconnect the client device 10 from the second auxiliary network 320 such that the client device 120 may transmit the other access request to the AP 110 at step S714. The other access request may be in the form of a probe response request frame or may be included in the probe request frame. It should be noted that step S713 may be performed in parallel with step S711 or step S712.

At step S715, the AP 110 may return, to the client device 120, a connection indication instructing the client device 120 to establish a connection with the AP 110 according to the WPA3 protocol. The connection indication may be in the form of a probe response frame or may be included in the probe response frame.

At step S716, the client device 120 and the AP 110 may perform the SAE authentication process specified by the WPA3 protocol using the target private PSK. For example, both the client device 120 and the AP 110 may calculate their own the confirm fields based on the same target private PSK, such that the calculated confirm fields of the client device 120 and the AP 110 are the same, thereby the four-way handshake process specified by the WPA3 can be carried out.

As such, the AP 110 can acquire the target private PSK to be used by the client device 120 to connect to the target network 130 via the unencrypted second auxiliary network 320 and the portal server 310 which uses portal authentication protocol, thereby ensuring that the client device 120 and the AP 110 use the same target private PSK to perform the SAE authentication process. This can ensure the success of the SAE authentication process as long as the target private PSK is correct and facilitates the client device 120 to connect to the target network according to the WPA3 protocol.

The first to third embodiments have been described above with reference to FIGS. 1 to 7. It should be noted that the intermediate server 210 in FIG. 4 and the portal server in FIG. 6 are shown as being outside of the AP 110, but in some instances, they may also be within the AP 110.

In addition, the network administrator may configure a unique private PSK for the client device 120 at the data management server 140 and may bind the unique private PSK to the MAC address of the client device 120. After receiving the access request including the MAC address of the client device 120 from the client device 120, the AP 110 may allow the client device 120 to connect to the target network 130 using the unique private PSK according to the WPA3 protocol in response to determining the MAC address in the access request matches the MAC address of the client device 120.

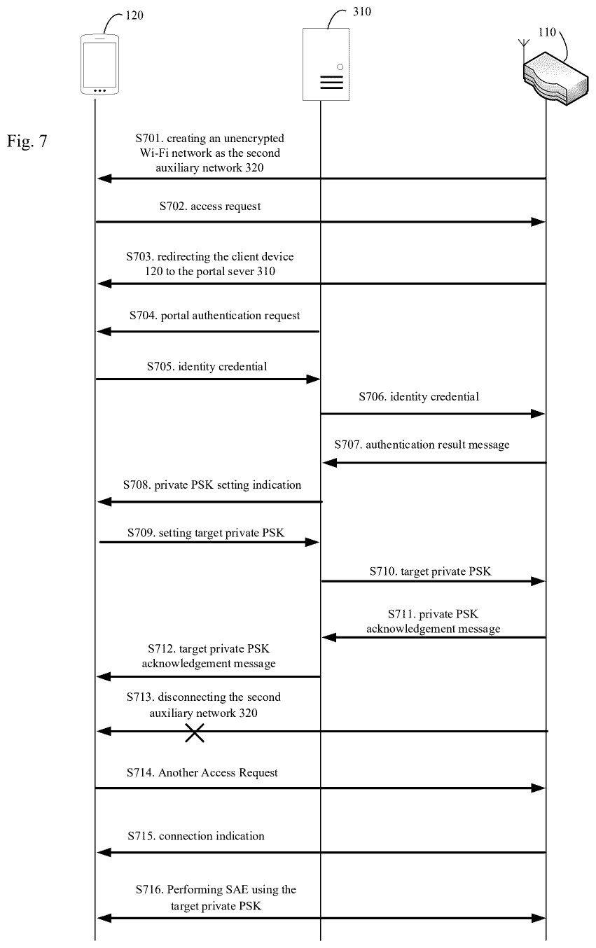

FIG. 8 shows an exemplary schematic diagram illustrating an example flow chart of the method of establishing a wireless network by the AP 110 according to an embodiment of the present disclosure.

Referring to FIG. 8, method 800 of establishing a wireless network by the AP 110 may comprise steps S810 to S830.

At step S810, the AP 110 may receive an access request indicating that the client device 120 is requesting access to the target network 130 using the WPA3 protocol created by the AP 110. For example, in the first embodiment of the present disclosure, the AP 110 may receive the access request from the client device 120 as described regarding step S201 in FIG. 2. In the second embodiment of the present disclosure, the AP 110 may receive the access request from the intermediate server 210 as described regarding steps S501 to S505 in FIG. 5. In the third embodiment of the present disclosure, the AP 110 may receive the access request from the client device 120 as described regarding steps S701 and S702 in FIG. 7.

At step S820, the AP 110 may acquire the target private PSK to be used by the client device 120 to connect to the target network 130 according to a security protocol different from the WPA3 protocol. For example, in the first embodiment of the present disclosure, the AP 110 may acquire the target private PSK according to the WPA2 protocol, as described regarding steps S202 to S204 in FIG. 2. In the second embodiment of the present disclosure, the AP 110 may acquire the target private PSK via the first auxiliary network 220 that uses the HTTPS protocol, as described regarding step S506 in FIG. 5. In the third embodiment of the present disclosure, the AP 110 may acquire the target private PSK via the second auxiliary network 320 and the portal server 310 that uses the portal authentication protocol, as described regarding steps S703 and S710 in FIG. 7.

At step S830, the AP 110 may control the client device 120 to connect to the target network 130 according to the WPA3 protocol in response to the target private PSK being correct. For example, in the first embodiment of the present disclosure, the AP 110 may control the client device 120 to connect to the target network 130 according to the WPA3 protocol by disconnecting the pre-connection established according to the WPA2 protocol and transmitting the connection indication to the client device 120 after receiving the other access request automatically transmitted by the client device 120, as described regarding steps S205 to S208 in FIG. 2. In the second embodiment of the present disclosure, the AP 110 may control the client device 120 to connect to the target network 130 according to the WPA3 protocol by transmitting a verification result message indicating the target private PSK is correct to trigger the intermediate server 210 to transmit the connection indication to the client device 120, as described regarding through steps S507 to S509 in FIG. 5. In the third embodiment of the present disclosure, the AP 110 may control the client device 120 to connect to the target network 130 according to the WPA3 protocol by disconnecting the pre-connection between the client device 120 and the unencrypted second auxiliary network and transmitting the connection indication to the client device 120 after the client device 120 automatically transmit the other access request, as described regarding steps S711 to S716 in FIG. 7.

In this way, the AP can acquire the target private PSK to be used by the client device 120 to connect to the target network 130 according to the WPA3 protocol through a security protocol different from the WPA3 protocol, resulting in the client device and the AP being able to use the same private PSK to perform the SAE process, thereby ensuring the success of the SAE authentication process, and finally facilitating the client device can access the target network according to the WPA3 protocol.

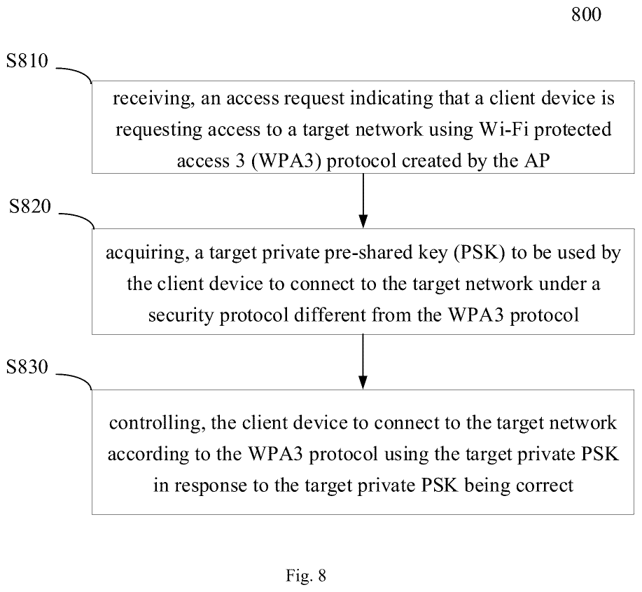

FIG. 9 shows an exemplary schematic diagram illustrating an example flow chart of the method of establishing a wireless network by the client device 120 according to an embodiment of the present disclosure.

Referring to FIG. 9, method 900 of establishing a wireless network by the client device 120 may comprise steps S910 to S930.

At step S910, the client device 120 may transmit to the AP 110 an access request indicating that the client device 120 is requesting access to the target network 130 using the WPA3 protocol provided by the AP 110. For example, in the first embodiment of the present disclosure, the client device 120 may transmit the access request as described regarding step S201 in FIG. 2. In the second embodiment of the present disclosure, the client device 120 may transmit the access request via the first auxiliary network 220 as described regarding steps S501 to S505 in FIG. 5. In the third embodiment of the present disclosure, the client device 120 may transmit the access request via the second auxiliary network 320 as described regarding steps S701 and S702 in FIG. 7.

At step S920, the client device 120 may transmit to the AP 110 the target private PSK to be used by the client device 120 to connect to the target network 130 according to a security protocol different from the WPA3 protocol. For example, in the first embodiment of the present disclosure, the client device 120 may transmit the target private PSK to the AP 110 according to the WPA2 protocol as described regarding step S203 in FIG. 2. In another example, the client device 120 may transmit the target private PSK to the AP 110 via intermediate server 210 according to the HTTPS protocol as described regarding steps S504 to S505 in FIG. 5. In the third embodiment of the present disclosure, the client device 120 may transmit the target private PSK to the AP 110 via portal server 210 according to the portal authentication protocol as described regarding S703 to S710 as shown in FIG. 7.

At step S930, the client device 120 may perform the SAE authentication process specified by the WPA3 protocol using the private PSK in response to receiving a connection indication instructing the client device 120 to establish a connection with the AP 110 according to the WPA3 protocol. For example, in the first embodiment of the present disclosure, the AP 110 may perform the SAE authentication process using the private PSK in response to receiving the connection indication from the AP 110 as described regarding steps S207 and S208 in FIG. 2. In the second embodiment of the present disclosure, the client device 120 may perform the SAE authentication process using the private PSK in response to receive the connection indication from the intermediate server 210 via the first auxiliary network 220 as described regarding steps S507 and S509 in FIG. 2. In the third embodiment of the present disclosure, the client device 120 may perform the SAE authentication process using the private PSK in response to receive the connection indication from the AP 110 as described regarding S713 to S716 shown in FIG. 7.

In this way, the client device can transmit to the AP 110 the target private PSK to be used by the client device 120 to connect to the target network 130 according to the WPA3 protocol through a security protocol different from the WPA3 protocol to enable the AP 110 to know the target private PSK before performing the SAE authentication process, resulting in the client device and the AP being able to use the same private PSK to perform the SAE process, thereby ensuring the success of the SAE authentication process, and finally facilitating the client device to access the target network according to the WPA3 protocol.

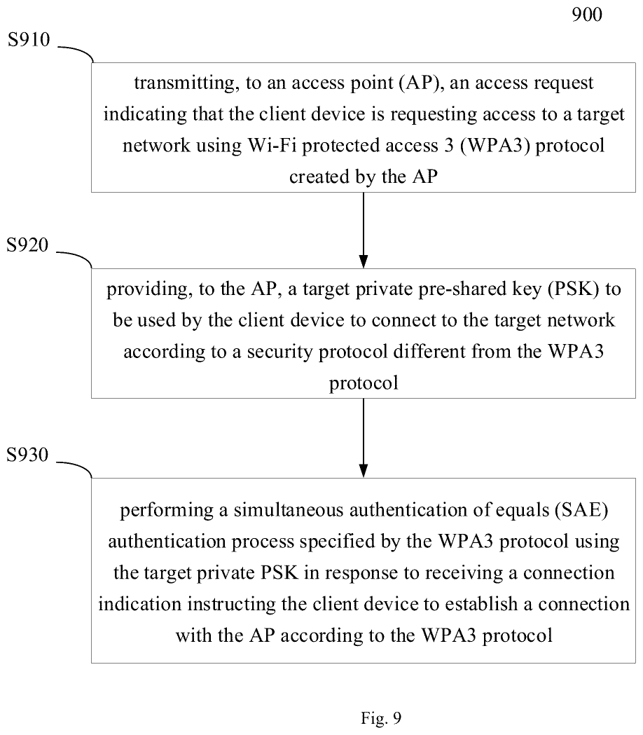

FIG. 10 is an exemplary block diagram illustrating an example AP according to an embodiment of the present disclosure.

As shown in FIG. 10, the AP 1000 according to an embodiment of the present disclosure may comprise a processor 111, a memory 112, a transmitting unit 113, and a receiving unit 114. These components may be coupled together via a communication bus 115. Memory 112 may store instructions thereon that, when executed by the processor 111 causes the AP 110 to perform the method 800 as previously described.

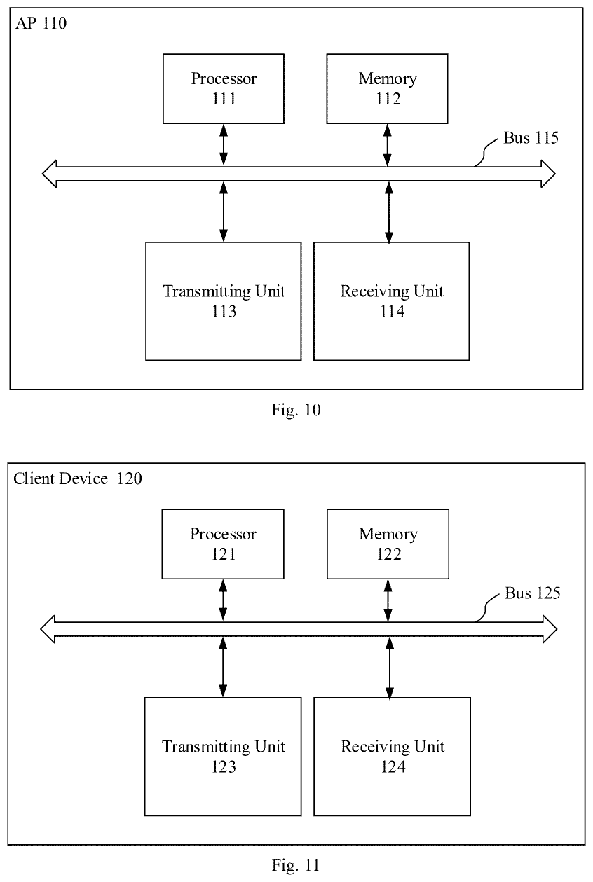

FIG. 11 is an exemplary block diagram illustrating an example client device according to an embodiment of the present disclosure.

As shown in FIG. 11, the client device 120 according to an embodiment of the present disclosure may comprise a processor 121, a memory 122, a transmitting unit 123, and a receiving unit 124. These components may be coupled together via a communication bus 125. Memory 122 may store instructions thereon that, when executed by the processor 121 causes the AP 120 to perform the method 900 as previously described.

Examples of the processors 111 and 121 may comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout the present disclosure.

Each of the processors 111 and 121 can execute software. The respective software shall be construed broadly to mean instructions, instruction sets, code, code segments, program code, programs, subprograms, software modules, applications, software applications, software packages, routines, subroutines, objects, executables, threads of execution, process, functions, etc., whether referred to as software, firmware, middleware, microcode, hardware description language, or otherwise. The respective software may reside on the memories 121 and 122, respectively.

Each of the memories 112 and 122 may be a non-transitory computer-readable medium. A non-transitory computer-readable medium comprises, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

In addition, according to another embodiment of the present disclosure, a computer program product for establishing a wireless network is disclosed. As an example, the computer program product comprises a computer-readable medium having program instructions embodied therewith, and the program instructions are executable by a processor. When executed, the program instructions cause the processor to perform one or more processes described above. The present disclosure may be a system, a method, and/or a computer program product at any possible technical detail level of integration. The computer program product may comprise a computer-readable storage medium having computer-readable program instructions thereon for causing a processor to carry out aspects of the present disclosure.

The present disclosure may be a system, a method, and/or a computer program product at any possible technical detail level of integration. The computer program product may comprise a computer-readable storage medium having computer-readable program instructions thereon for causing a processor to carry out aspects of the present disclosure.

An expression such as “according to”, “based on”, “dependent on”, and so on as used in the disclosure does not mean “according only to”, “based only on”, or “dependent only on” unless it is explicitly otherwise stated. In other words, such expression generally means “according at least to”, “based at least on”, or “dependent at least on”in the disclosure.

The term “determining” used in the disclosure can comprise various operations. For example, regarding “determining”, calculating, computing, processing, deriving, investigating, looking up (e.g., looking up in tables, databases, or other data structures), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth can also be regarded as “determining”. That is, regarding “determining”, several actions can be regarded as “determining”.

The terms such as “connected”, “coupled” or any of their variants used in the disclosure refer to any connection or combination, direct or indirect, between two or more units, which can comprise the following situations: between two units that are “connected” or “coupled” with each other, there are one or more intermediate units. The coupling or connection between the units can be physical or logical or can also be a combination of the two. As used in the disclosure, two units can be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure can be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method of establishing a wireless connection by an access point (AP), comprising:
receiving an access request indicating that a client device is requesting access to a target network using Wi-Fi protected access 3 (WPA3) protocol created by the AP;
acquiring a target private pre-shared key (PSK) to be used by the client device to connect to the target network according to a security protocol different from the WPA3 protocol; and
controlling the client device to connect to the target network according to the WPA3 protocol using the target private PSK in response to the target private PSK being correct.

2. The method of claim 1, wherein the security protocol comprises:
Wi-Fi protected access 2 (WPA2) protocol;
hypertext transfer protocol secure (HTTPS) protocol; or
portal authentication protocol.

3. The method of claim 2, wherein the security protocol is the WPA2 protocol, and wherein the acquiring the target private PSK comprises:
transmitting, to the client device, an access request response instructing the client device to establish a pre-connection with the AP according to the WPA2 protocol in response to receiving the access request; and
acquiring, from the client device, the target private PSK during the establishment of the pre-connection with the client device according to the WPA2 protocol.

4. The method of claim 1, wherein
a set of private PSKs associated with the client device is not bound to a media access control (MAC) address, and the target private PSK being correct is determined based on the target private PSK matching one private PSK of the set of private PSKs; or
the set of private PSKs is bound to a MAC address, and the target private PSK being correct is determined based on the target private PSK matching one private PSK of the set of private PSKs and the MAC address of the client device comprised in the access request matching the MAC address to which the set of private PSKs is bound.

5. The method of claim 3, wherein controlling the client device to connect to the target network according to the WPA3 protocol comprises:
disconnecting the client device from the established pre-connection, such that the client device transmits another access request indicating that the client device is requesting access to the target network to the AP;
transmitting, to the client device, a connection indication instructing the client device to establish a connection with the AP according to the WPA3 protocol in response to receiving the other access request; and
performing the simultaneous authentication of equals (SAE) authentication process specified by the WPA3 protocol using the target private PSK.

6. The method of claim 2, wherein the security protocol is the HTTPS protocol, and wherein the acquiring the target private PSK comprises:
acquiring the target private PSK from the access request in response to receiving the access request from an intermediate server associated with the AP via a first auxiliary network using the HTTPS protocol, and
wherein the intermediate server is configured to transmit a list of networks comprising the target network to the client device via the first auxiliary network and to transmit a private PSK request for requesting the target private PSK to the client device via the first auxiliary network in response to the target network being selected.

7. The method of claim 6, wherein controlling the client device to connect to the target network according to the WPA3 protocol comprises:
transmitting, to the intermediate server, a verification result message indicating the target private PSK being correct via the first auxiliary network; and
performing a simultaneous authentication of equals (SAE) authentication process specified by the WPA3 protocol using the target private PSK,
wherein the intermediate server is configured to transmit to the client device a connection indication instructing the client device to establish a connection with the AP according to the WPA3 protocol in response to receiving the verification result message.

8. The method of claim 2, wherein the security protocol is the portal authentication protocol, and wherein the acquiring the target private PSK comprises:
redirecting the client device to a portal server using the portal authentication protocol associated with the AP in response to receiving the access request from the client device via a second auxiliary network which is unencrypted and created by the AP, such that the portal server transmits to the client device a portal authentication request for requesting an identity credential of the client device;
receiving the identity credential of the client device from the portal server;
transmitting, to the portal server, an authentication result message indicating the authentication being successful in response to the identity credential being correct, such that the portal server transmits to the client device a private PSK setting indication instructing the client device to set the target private PSK; and
receiving the target private PSK from the portal server.

9. The method of claim 8, wherein the target private PSK being correct is based on a verification of the identity credential being successful.

10. The method of claim 8, wherein controlling the client device to connect to the target network according to the WPA3 protocol comprises:
disconnecting the client device from the second auxiliary network after receiving the target private PSK, such that the client device transmits another access request indicating that the client device is requesting access to the target network to the AP;
transmitting, to the client device, a connection indication instructing the client device to establish the connection with the AP according to the WPA3 protocol; and
performing a simultaneous authentication of equals (SAE) authentication process specified by the WPA3 protocol using the target private PSK.

11. The method of claim 10, further comprising:
transmitting a private PSK acknowledgment message to the portal server in response to receiving the target private PSK such that the portal server forwards the private PSK acknowledgment message to the client device.

12. A method for establishing a wireless connection by a client device, comprising:
transmitting, to an access point (AP), an access request indicating that the client device is requesting access to a target network using Wi-Fi protected access 3 (WPA3) protocol created by the AP;
providing, to the AP, a target private pre-shared key (PSK) to be used by the client device to connect to the target network according to a security protocol different from the WPA3 protocol; and
performing a simultaneous authentication of equals (SAE) authentication process specified by the WPA3 protocol using the target private PSK in response to receiving a connection indication instructing the client device to establish a connection with the AP according to the WPA3 protocol.

13. The method of claim 12, wherein the security protocol comprises:
Wi-Fi protected access 2 (WPA2) protocol;
hypertext transfer protocol secure (HTTPS) protocol; or
portal authentication protocol.

14. The method of claim 13, wherein the security protocol is the WPA2 protocol, and wherein the providing the target private PSK comprises:
receiving, from the AP, an access request response instructing the client device to establish a pre-connection with the AP according to the WPA2 protocol; and
establishing the pre-connection with the AP according to the WPA2 protocol such that the AP acquires the target private PSK during the establishment of the pre-connection.

15. The method of claim 13, wherein the security protocol is the HTTPS protocol, and wherein the providing the target private PSK comprises:
receiving a list of networks comprising the target network from an intermediate server associated with the AP via a first auxiliary network using the HTTPS protocol;
selecting the target network from the list of networks;
transmitting the target private PSK to the intermediate server via the first auxiliary network in response to receiving a private PSK request for the target private PSK of the client device from the intermediate server,
wherein the intermediate server is configured to transmit the access request comprising the target private PSK to the AP in response to receiving the target private PSK.

16. The method of claim 13, wherein the security protocol is the portal authentication protocol, and wherein the providing the target private PSK comprises:
transmitting, to the AP, the access request via a second auxiliary network which is unencrypted and created by the AP, such that the AP redirects the client device to a portal server associated with the AP;
transmitting, to the portal server, an identity credential of the client device in response to receiving a portal authentication request from the portal server; and
transmitting, to the portal server, the target private PSK in response to receiving a private PSK setting indication from the portal server.

17. An access point (AP), comprising:
a memory, storing instructions thereon; and
a processor, coupled with the memory, the processor is configured to execute the instructions to cause the AP to:
receive an access request indicating that a client device is requesting access to a target network using Wi-Fi protected access 3 (WPA3) protocol created by the AP;
acquire a target private pre-shared key (PSK) to be used by the client device to connect to the target network according to a security protocol different from the WPA3 protocol; and
control the client device to connect to the target network according to the WPA3 protocol using the target private PSK in response to the target private PSK being correct.

18. The AP of claim 17, wherein the security protocol is a Wi-Fi protected access 2 (WPA2) protocol, and wherein to acquire the target private PSK, the processor is configured to execute the instructions to cause the AP to:
transmit, to the client device, an access request response instructing the client device to establish a pre-connection with the AP according to the WPA2 protocol in response to receiving the access request; and
acquire, from the client device, the target private PSK during the establishment of the pre-connection with the client device according to the WPA2 protocol.

19. The AP of claim 17, wherein the security protocol is a hypertext transfer protocol secure (HTTPS) protocol, and wherein to acquire the target private PSK, the processor is configured to execute the instructions to cause the AP to:
acquire the target private PSK from the access request in response to receiving the access request from an intermediate server associated with the AP via a first auxiliary network using the HTTPS protocol, and
wherein the intermediate server is configured to transmit a list of networks comprising the target network to the client device via the first auxiliary network and to transmit a private PSK request for requesting the target private PSK to the client device via the first auxiliary network in response to the target network being selected.

20. The AP of claim 17, wherein the security protocol is a portal authentication protocol, and wherein to acquire the target private PSK, the processor is configured to execute the instructions to cause the AP to:
redirect the client device to a portal server using the portal authentication protocol associated with the AP in response to receiving the access request from the client device via a second auxiliary network which is unencrypted and created by the AP, such that the portal server transmits to the client device a portal authentication request for requesting an identity credential of the client device;
receive the identity credential of the client device from the portal server;
transmit, to the portal server, an authentication result message indicating the authentication being successful in response to the identity credential being correct, such that the portal server transmits to the client device a private PSK setting indication instructing the client device to set the target private PSK; and
receive the target private PSK from the portal server.
